(19) United States
(12) Patent Application Publication
(10) Pub. No.: US 2008/0267611 A1
(43) Pub. Date: Oct. 30, 2008

(54) ROTATABLE CAMERA

(76) Inventor: Chao-Tan HUANG, Yung-he City (TW)

Correspondence Address: RABIN & BERDO, P.C., Suite 500, 1101 14 Street, Washington, DC, 20005, US

(21) Appl. No.: 11/954,042

(22) Filed: Dec. 11, 2007

(30) Foreign Application Priority Data
Apr. 30, 2007 (TW) 096115236

(51) Int. Cl. G03B 17/00; H04N 7/18

(52) U.S. Cl. 396/427; 348/143; 348/E07.085

(57) ABSTRACT

A rotatable camera comprises a camera and a fixing seat, wherein the camera and the fixing seat are assembled respectively with a coil for electrical conduction, such that after the camera and the fixing seat are assembled, an electric conduction can be accomplished by the coils, allowing the camera to rotate by 360 degrees without having interference points, so as to achieve a function of monitoring without having blind angles.

### BACKGROUND OF THE INVENTION

a) Field of the Invention

The present invention relates to a rotatable camera, and more particularly to a rotatable camera that is set up in a site for surveillance, and can rotate by 360 degrees without having interference points.

b) Description of the Prior Art

A camera is a very popular electronic device. In some circumstances, the camera would have functions of moving upward and downward, and of rotating left and right. For the rotatable cameras, the most difficult problem to be overcome is to rotate the cameras by 360 degrees without having interference points. Since there are at least one signal line and one power line need to be passed through a bottom seat of the camera, if the bottom seat of the camera rotates by 360 degrees continuously, then the signal line and the power line will be inevitably twisted off. For this reason, some entry level cameras just simply set up to rotate back and forth within a certain fixed angle limit, and some other more advanced cameras use slip ring to achieve zero interference points. Referring to FIG. 1, it shows a schematic view of a conventional slip ring, wherein a slip ring structure 10 includes a body 101 and a wiring 102, allowing the camera to rotate by 360 degrees continuously. However, this kind of slip ring structure is very expensive. Therefore, only small numbers of cameras are equipped with this device and prohibiting the camera from fully developing its monitoring function.

### SUMMARY OF THE INVENTION

Accordingly, the primary object of the present invention is to provide a camera that can rotate by 360 degrees without having the interference points, to meet a requirement of no blind angles in setting up the camera. The present invention applies a principle of electromagnetic induction to transmit electricity by coils, without requiring the power line to pass through the bottom of the camera. In addition, in terms of signal transmission, a wireless transmission method is used to remove the signal line, thereby allowing the camera to rotate without having interference points.

Accordingly, the rotatable camera provided by the present invention is constituted by a camera and a fixing seat. The camera is provided with a rotation mechanism and a first coil, and the fixing seat includes a second coil which is coupled with a transmission line. After the rotation mechanism is assembled with the fixing seat, the camera can rotate on the fixing seat. Moreover, the first coil is coupled with the camera, and the second coil is coupled with the transmission line. By using the first coil and the second coil, electricity can be conducted to the camera from the fixing seat, allowing the camera to operate electrically and to rotate by 360 degrees, thereby achieving an application requirement of monitoring without having the blind angles.

To enable further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional slip ring structure.

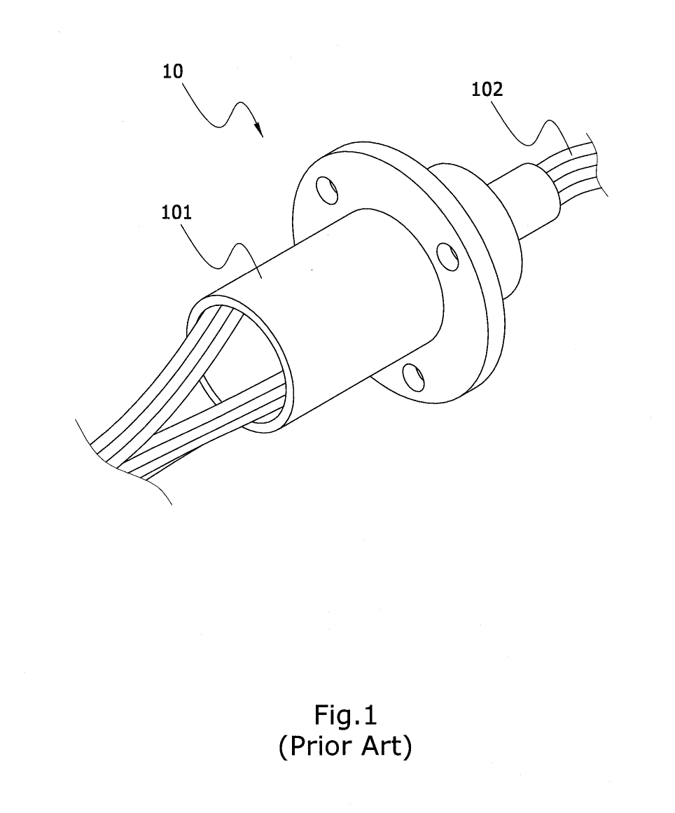

FIG. 2 shows a perspective view of the present invention.

FIG. 3 shows a cutaway view of the present invention.

FIG. 4 shows a schematic view of an operation of the present invention.

FIG. 5 shows a schematic view of elements of the present invention.

### DETAILED DESCRIPTION OF THE PREFERRED EMBODIMENTS

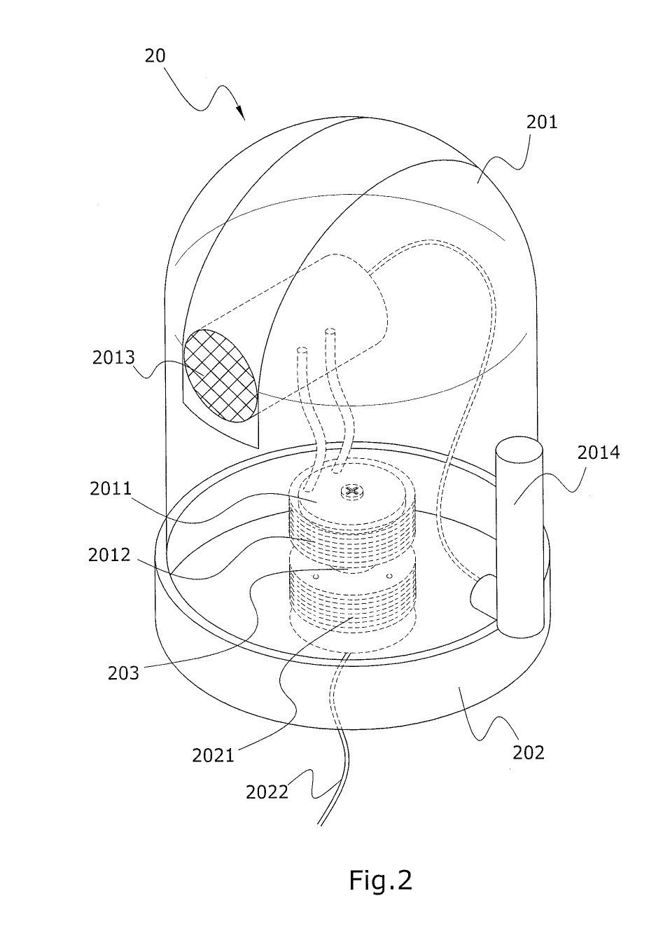

Referring to FIG. 2, a rotatable camera 20 disclosed by the present invention comprises primarily a camera 201 and a fixing seat 202, wherein the camera 201 includes an image module 2013 for capturing dynamic or static images. A bottom of the camera 201 is assembled with a rotation mechanism 2011 which is provided with a first coil 2012. As shown in the drawing, the fixing seat 202 is provided with a second coil 2021 which is connected with a transmission line 2022. The transmission line 2022 can transmit electricity. In addition, a rotating shaft 203 is movably assembled between the first coil 2012 and the second coil 2021, and is therefore pivoted after being assembled. The first coil 2012 and the second coil 2021 can rotate with respect to each other, and electricity is transmitted by the coils by using a principle of electromagnetic induction, such that there is no need to pass a power line through the bottom of the camera 201. Furthermore, the aforementioned first coil 2012 and second coil 2021 are made by metallic wires, and their surfaces are enclosed by an insulating material. For the rotatable camera 20 of the present invention, power is transmitted to the camera 201 by the first coil 2012 and the second coil 2021. The camera 201 is further provided with a wireless communication unit (not shown in the drawing) and a wireless receiving device 2014 by which the camera 201 can conduct a wireless communication with an external device (such as a wireless network base station). As this part belongs to an application of a conventional microprocessor system and communication technology, no further description is needed. In other words, by applying the principle of electromagnetics, and through secondary coils for transmitting electricity, the power is provided to the camera 201 by the fixing seat 202 without contacting. Accordingly, as electricity can be transmitted to the camera 201 from the fixing seat 202, there will be no wirings existed between the camera 201 and the fixing seat 202, and hence there is no interference point, allowing the camera 201 to rotate by 360 degrees without any limitation.

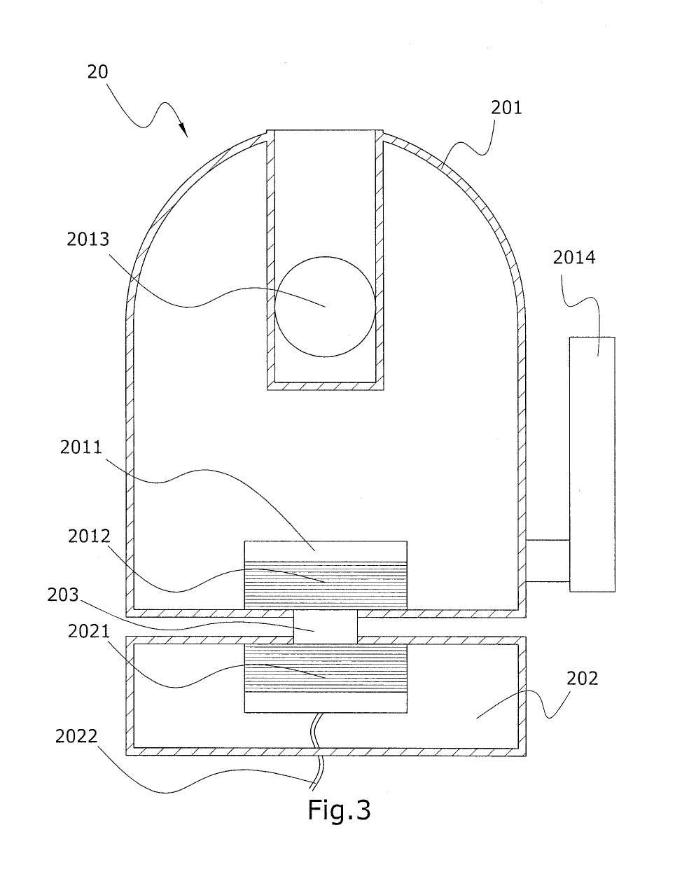

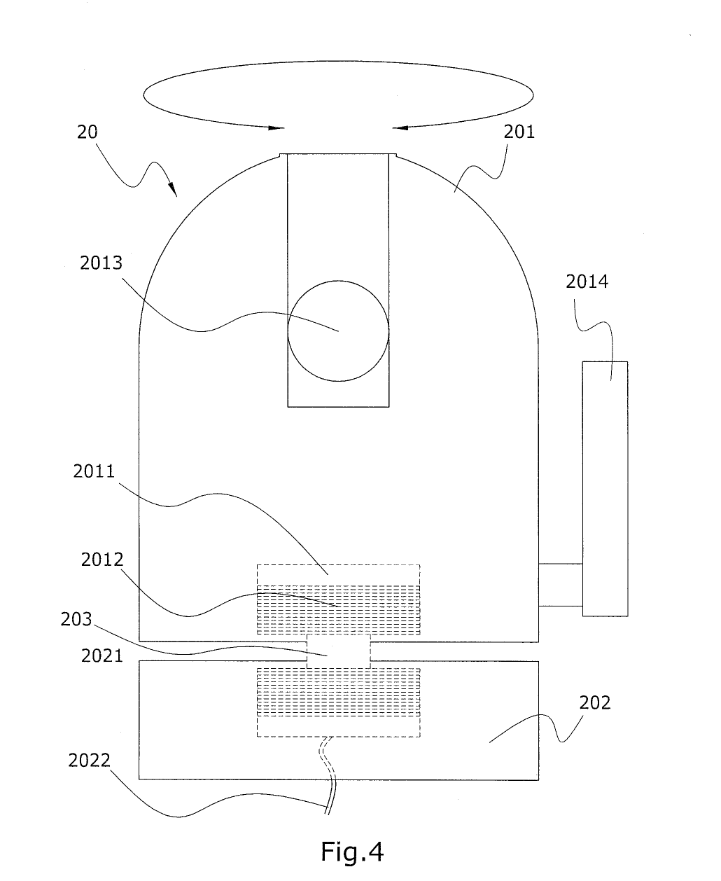

FIG. 3 and FIG. 4 show respectively a cutaway view and a schematic view of an operation of the present invention. As shown in FIG. 3, the first coil 2012 at the bottom of the camera 201 is assembled relative to the second coil 2021 of the fixing seat 202 by a rotating shaft 203. After assembling, the two coils can rotate with respect to each other by the rotating shaft 203. Moreover, as the second coil 2021 is connected with the transmission line 2022, electricity can be introduced through the transmission line 2022; and by using the principle of electromagnetic induction, even when the first coil 2012 is rotating, it can still continuously receive the electricity from the second coil 2021. Therefore, even the camera 201 has rotated by 360 degrees; it is still not interfered by any wiring or device, and the visual angle of monitoring of the camera can be largely increased. FIG. 4 shows a schematic view of an operation of the camera 201.

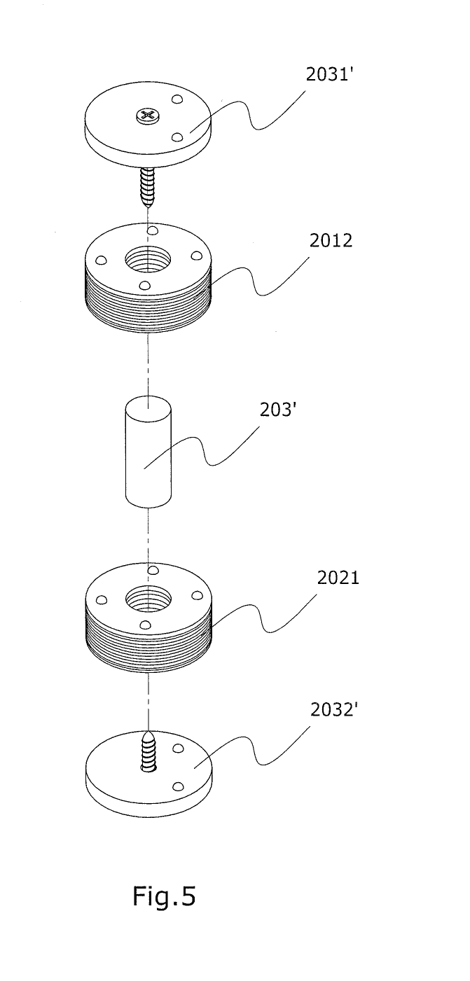

Referring to FIG. 5, an embodiment of the rotation mechanism 2011 can be an I-shape rotating shaft 203′ (or the rotating shaft 203 in the original embodiment). As shown in the drawing, the rotation mechanism 2011 and the fixing seat 202 are assembled by this I-shape rotating shaft 203′. An upper section 2031′ of the I-shape rotating shaft 203′ is assembled at a bottom end of the camera 201, and a lower section 2032′ is assembled at the fixing seat 202. On the other hand, the upper section 2031′ of the I-shape rotating shaft 203′ is serially connected with the first coil 2012, and the lower section 2032′ of the I-shape rotating shaft 203′ is serially connected with the second coil 2021. In addition, the first coil 2012 and the second coil 2021 are constituted by enameled copper wires.

Accordingly, the present invention provides a rotatable camera, wherein electricity is transmitted by electromagnetic induction, allowing no wires passing through a bottom seat of the camera, and hence enabling the camera to be free from affection by interference points, thereby resulting in rotation by 360 degrees continuously. On the other hand, as materials used by the present invention are all electronic elements which are commonly used in electronics industries, the present invention will have a low price, which apparently can effectively solve a shortcoming of high price for the conventional solution, and therefore facilitate a full population of camera technology of 360 degrees of rotation and without having the interference points. Accordingly, after being implemented, the present invention can truly provide a camera which is free from the interference points, and can rotate by 360 degrees continuously, thereby meeting a requirement of setting up the camera without having blind angles.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A rotatable camera, which is set up in a site for capturing images there, comprising a camera, a bottom of which is provided with a rotation mechanism having a first coil; a fixing seat which is provided with a second coil being connected with a transmission line; and a rotating shaft, which is located between said first coil and said second coil, allowing said first coil and said second coil to rotate with respect to each other, after assembling.

2. The rotatable camera according to claim 1, wherein said electricity is introduced through said transmission line.

3. The rotatable camera according to claim 1, wherein said camera is provided with a wireless communication unit to conduct a wireless contact with at least one external device.

4. A rotatable camera, which is set up in a site to capture images in the site, comprising a camera, a bottom of which is assembled with a rotation mechanism having a first coil; a fixing seat which is assembled with a second coil being connected with a transmission line; and an I-shape rotating shaft, an end of which is assembled with an upper section for installing said first coil, and the other end of which is assembled with a lower section for installing said second coil; after assembling, said first coil and said second coil can rotate with respect to each other.

5. The rotatable camera according to claim 4, wherein said electricity is introduced through said transmission line.

6. The rotatable camera according to claim 4, wherein said camera is assembled with a wireless communication unit to conduct a wireless communication with at least one external device.
